(19) United States
(12) Patent Application Publication
(10) Pub. No.: US 2004/0183044 A1
(43) Pub. Date: Sep. 23, 2004

(54) Severe service control valve

(76) Inventor: William Everett Wears, Marshalltown, IA (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/393,232

(22) Filed: Mar. 20, 2003

(51) Int. Cl. F16K 31/00

(52) U.S. Cl. 251/206; 251/344

(57) ABSTRACT

A severe service control valve is disclosed and which comprises a valve body having an inlet, an outlet, and a flow passage extending between the inlet and the outlet, an elongated valve contour disposed within the valve body, a tubular valve sleeve disposed within the valve body and having an end sized to be received over the valve contour, the valve sleeve having a sidewall surrounding a bore, an outer surface and an inner surface, with at least a portion of the bore disposed along the flow passage. The valve sleeve is shiftably mounted within the valve body for movement between a first position and a second position, the valve sleeve cooperating with the valve contour to close the flow passage when the valve sleeve is in the first position. A plurality of flow apertures are defined through the sidewall of the valve sleeve and define a flow path between the outer surface of the valve sleeve and the inner surface of the valve sleeve, the apertures arranged on the sidewall to be positioned in the flow passage when the valve sleeve is moved toward the second position.

### FIELD OF THE INVENTION

The present invention relates generally to control valves having axially moveable valve sleeves and, more specifically, to a severe service control valve having a valve sleeve guided by an elongated valve contour.

### BACKGROUND OF THE INVENTION

Control valves for controlling the flow of high pressure fluids and/or gases in a process system are generally well known in the art. In many applications, such control valves are subject to severe operating conditions including, by way of example rather than limitation, high temperature, high pressure, and vibration. In many process systems, there may be a severe energy drop or pressure loss across the valve, which may cause damaging shock waves and/or cavitation, both of which may cause erosion of the internal components of the valve and/or cause excessive noise in the process system.

Further, as the internal components of the valve are eroded, the flow characteristics of the valve are gradually altered over time. The altered flow characteristics may be unpredictable and erratic, thus greatly complicating control of the process system.

Accordingly, continual improvements in the construction and/or operation of control valves and their associated components may be desired.

### BRIEF DESCRIPTION OF THE DRAWINGS

FIG. 1 illustrates a prior art axial control valve;

FIG. 2 is a split cross-sectional view of an axial control valve assembled in accordance with the teachings of the present invention and incorporating a series of apertures through the valve sleeve;

FIG. 2A is an enlarged fragmentary view taken at an end of the valve sleeve adjacent the valve contour;

FIG. 3 is a split cross-sectional view similar to FIG. 2 but employing an alternate form for the apertures through the valve sleeve;

FIG. 4 is a split cross-sectional view similar to FIGS. 2 and 3 but employing a series of stacked discs to form an end portion of the valve sleeve;

FIG. 5 is an exploded view in perspective of an exemplary form for the stacked discs for use with the valve sleeve of FIG. 4;

FIG. 6 is a split cross-sectional view similar to FIGS. 2-4 but illustrating an optional rotary actuator for use with any of the valves depicted in FIGS. 1-4;

FIG. 7 is a top plan view of the valve sleeve of FIG. 6;

FIG. 8 is a split cross-sectional view similar to FIG. 6 but illustrating an optional cam actuator;

FIG. 9 is a top plan view of the valve sleeve of FIG. 8;

FIG. 10 is an enlarged fragmentary split cross-sectional view illustrating an alternate form for the valve contour employing a seal between the valve contour and the sleeve; and

FIG. 11 is an enlarged fragmentary split cross-sectional view illustrating an alternate location for the valve seat at the interface between the valve contour and the sleeve.

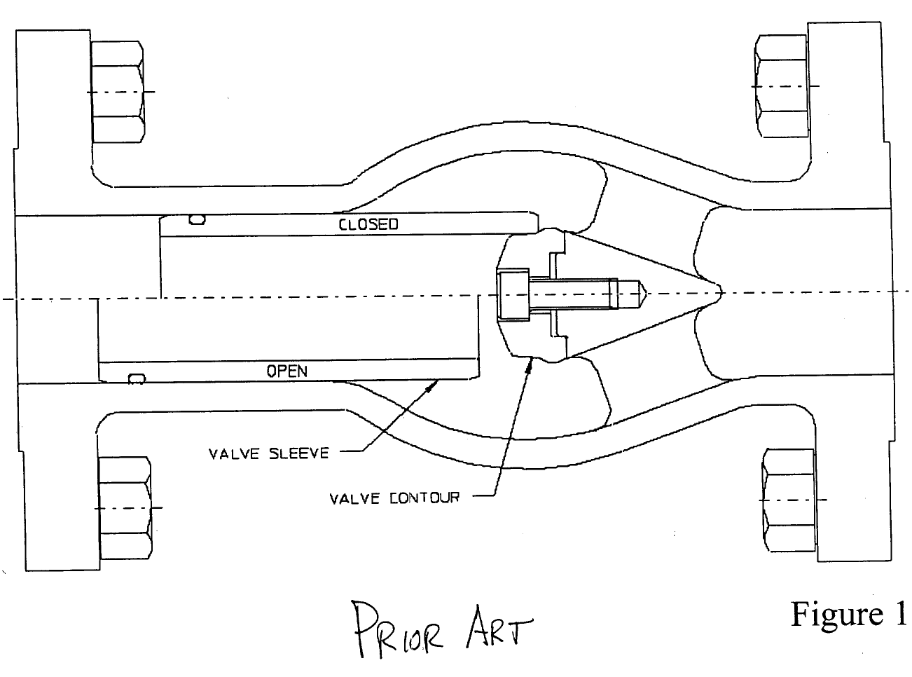

### DETAILED DESCRIPTION OF THE PREFERRED EMBODIMENTS

The embodiments described herein are not intended to be exhaustive or to limit the scope of the invention to the precise form or forms disclosed. Instead, the following embodiments have been described in order to best explain the principles of the invention and to enable others skilled in the art to follow its teachings.

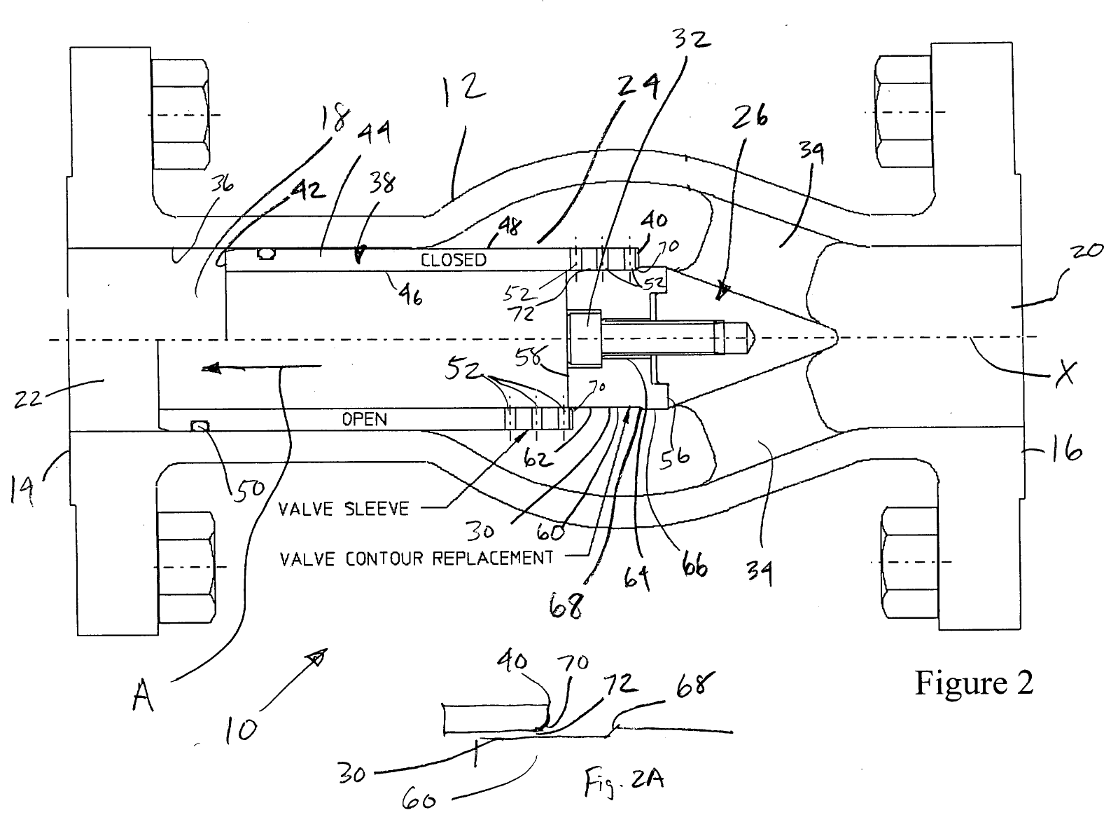

Referring now to FIG. 2 of the drawings, an axial control valve assembled in accordance with the teachings of a first disclosed example of the present invention is referred to by the reference numeral 10. The control valve 10 includes a body 12 having an inlet end 14 and an outlet end 16. A passage 18 is defined through the body 12 and includes an inlet passage 20, an outlet passage 22, and a control passage 24. A plug mount 26 is mounted within the body 12 of the control valve 10, with the plug mount 26 preferably being generally centrally located within the passage 18 of the body 12 such that the plug mount 26 is generally disposed along a longitudinal axis X of the body 12.

The plug mount 26 includes a valve contour 30 which is preferably removably attached to the plug mount 26, such as by the use of an attachment bolt 32. A plurality of vanes 34 provide support for the plug mount 26. In the disclosed example, the vanes 34 extend between the plug mount 26 and an inner surface 36 of the body 12. In the disclosed example, the vanes 34 are disposed generally parallel to the direction of flow (indicated by an arrow A in FIG. 2). Each of the vanes 34 will preferably have an airfoil-shaped cross section as is commonly employed in the art.

A valve sleeve 38 is disposed within the body 12 of the control valve 10 such that the valve sleeve 38 is movable along the longitudinal axis X, or generally parallel relative to the longitudinal axis X, between a first position in which the valve sleeve 38 is disposed toward the right when viewing FIG. 2, and a second position in which the valve sleeve 38 is disposed toward the left when viewing FIG. 2. It will be appreciated that the valve sleeve 38 is shown in split fashion when viewing FIGS. 2-4, with that portion of the valve sleeve 38 appearing above the longitudinal axis X shown in the first position, and with that portion of the valve sleeve 38 appearing below the longitudinal axis X appearing in the second position.

The valve sleeve 38 includes a pair of ends 40, 42, and an interconnecting side wall 44. The side wall 44 includes an inner surface 46 and an outer surface 48. In the disclosed example, the valve sleeve 38 is formed in a generally cylindrical shape. The valve sleeve 38 may be provided with one or more valve seals 50 as needed. The seal 50 may be an O-ring or any other suitable seal of the type commonly employed in the art. The valve sleeve 38 includes a plurality of apertures 52 which extend through the side wall 44 so as to provide one or more passages between the inner surface 46 of the side wall 44 and the outer surface 48 of the side wall 44. It will be understood that, according to the first disclosed example, these apertures 52 will form at least a portion of the cross-sectional area of the control passage 24.

The valve contour 30 includes an end 56 mounted to the plug mount 26, and includes an end 58 spaced away from the plug mount 26. The valve contour 30 includes an elongated central portion 60 extending between the ends 56 and 58, with the elongated central portion 60 including an outer surface 62. The valve contour 30 also includes a suitable mounting aperture 64 to enable the valve contour 30 to be removably attached to the plug mount 26 using the attachment bolt 32. Alternatively, the valve contour may be permanently affixed to the plug mount 26, or as a further alternative the valve contour 30 and the plug mount 26 may be integrally formed as a single unit.

The valve contour 30 also includes a flare or shoulder 66 which defines a valve seat 68. The valve seat 68 enables, in accordance with the disclosed example, a seal to be formed between the valve sleeve 38 and the valve contour 30 thus closing off the control passage 24 when the valve sleeve 38 is in the first position disposed all the way to the right when viewing FIGS. 2-4. Preferably, the end 40 of the valve sleeve 38 includes a shaped portion 70 (FIG. 2A) which is sized and shaped to mate with the valve seat 68 on the valve contour 30. In accordance with the disclosed example, the shaped portion 70 is preferably a curved shape following a radius such that the shaped portion 70 makes a line contact with the valve seat 68. Other shapes for the shaped portion 70 may prove suitable. It will be appreciated that the end 40 of the valve sleeve 38 may be sized relative to the outer surface 62 of the valve contour 30 such that a peripheral clearance space 72 is defined between the inner surface 46 of the valve sleeve 38 and the outer surface 62 of the elongated central portion 60 of the valve contour 30 (FIG. 2A). Thus, in accordance with the disclosed example the peripheral clearance space 72 may form at least a portion of the cross-sectional area of the control passage 24 when the valve sleeve 38 is moved away from the valve seat 68.

In operation, the control valve 10 may be used for flow control of any process medium such as liquid, gas, slurry, etc., wherein the process medium flows from the left toward the right in the direction A through the control valve 10 as shown in FIGS. 2-4. As would be known to those of skill in the art, the inlet end 14, the outlet end 16, the inlet and outlet passages 20, 22 and the control passage 24 may be designed in various shapes and sized for control of flow pressure and velocity. As would also be known to those of skill in the art, the pressure drop across the control valve 10 can be controlled by controlling the cross-sectional area of the inlet passage 20, the outlet passage 22, and the available cross-sectional area of the control passage 24. For example, in order to minimize a pressure drop across the control valve 10, the cross-sectional area of the various passages may be maintained at a constant value.

In further accordance with the disclosed example, the vanes 34 may have an airfoil-shaped cross-section which may serve to guide the flow of the process medium toward the outlet end 16. As would be known, this airfoil shape may serve to inhibit or limit disturbance of the flow of the process medium inside and downstream of the control passage 24. Further, the plug mount 26 may be cone-shaped to encourage the convergence of the flow as the process medium proceeds toward the outlet passage 22 of the control valve 10.

It also will be appreciated that when the valve sleeve 38 is disposed toward the right when viewing FIGS. 2-4, that the shaped portion 70 at the end 40 of the sleeve 38 will mate with the valve seat 68 defined on the shoulder 66 of the valve contour 30, such that flow of the process medium between the inlet passage 20 and the outlet passage 22 will be effectively interrupted. As the valve sleeve 38 is shifted toward the left when viewing FIGS. 2-4 and away from the first position, it will be appreciated that a number of the apertures 52 defined on the valve sleeve 38 will move away from the valve contour 30 such that a number of the apertures 52 will be disposed in the control passage 24, thus permitting flow of the process medium between the inlet passage 20 and the outlet passage 22 (e.g., by flowing through the passageway provided by the exposed apertures 52). It will be understood that the valve sleeve 38 may be shifted between the positions described above using any form of a suitable valve actuator (not shown) as would be apparent to those of skill in the art. Alternatively, the control valve 10 may be equipped with a valve actuation mechanism of the type described in greater detail below and as depicted in any of FIGS. 6 through 10.

As the valve sleeve 38 is moved all the way toward the left when viewing FIGS. 2-4 to the extend of its travel, a maximum number of the apertures 52 will be disposed in the control passage 24, thus causing a greater flow of the process medium between the inlet passage 20 and the outlet passage 22. Stated another way, as the valve sleeve 38 is moved away from the valve seat 68, the total area of the apertures 52 disposed in the control passage 24 is increased, thereby permitting increased flow. A suitable actuator of the type commonly employed in the art (not shown) may be provided for shifting the valve sleeve 38 between the first and second positions.

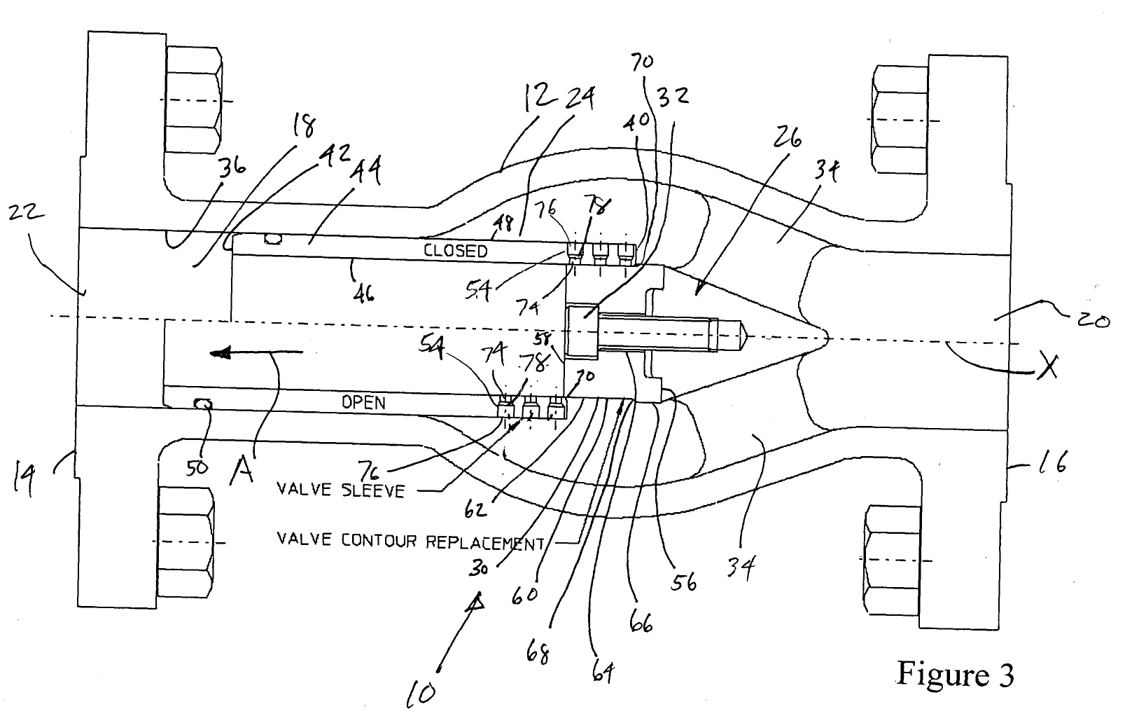

Referring again to FIG. 2, the apertures 52 may have a generally constant cross-section as the apertures 52 extend between the inner surface 46 and the outer surface 48 of the sidewall 44. Alternatively, and referring to FIG. 3, apertures 54 may be provided which have a variable cross-section. As shown in FIG. 3, the apertures 54 have a narrowed first portion 74, a widened second portion 76, and a transition zone 78. Other variable cross-sections (not shown) may be contemplated by those of skill in the art. When the flow path through the control valve 10 is as indicated by the arrow A, the process medium will encounter the widened second portion 76, the transition zone 78, and then the first portion 74 when passing through the apertures 54.

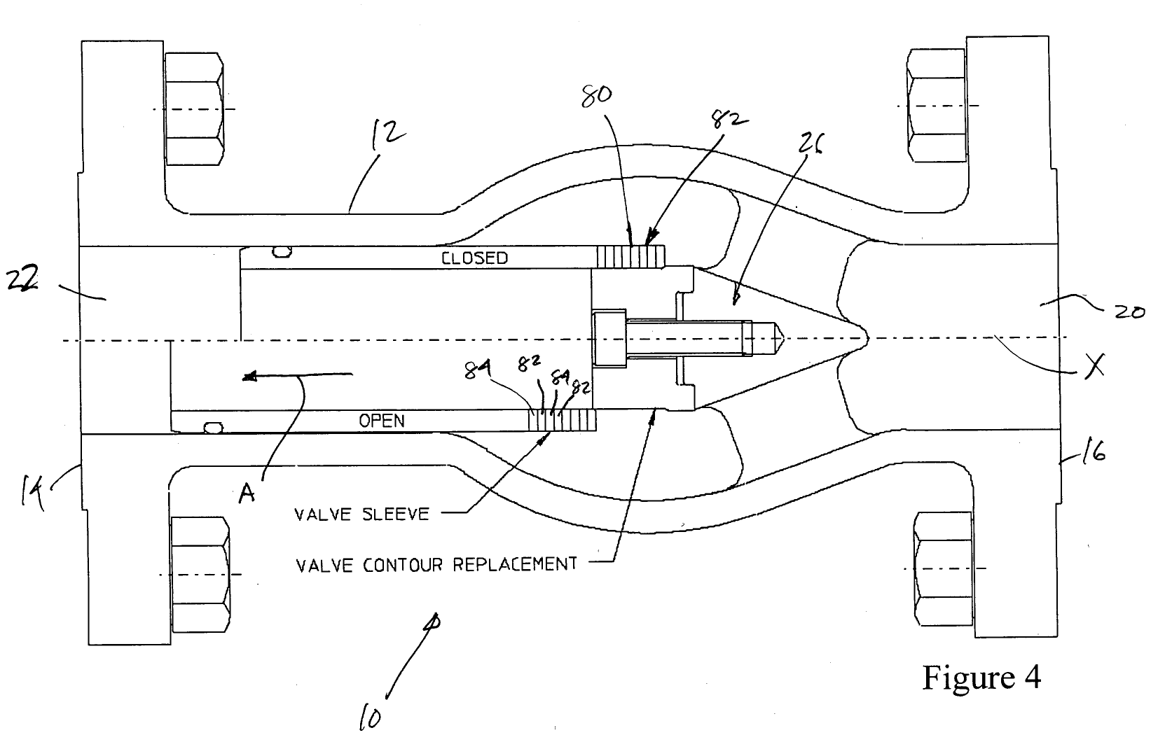

Referring now to FIG. 4, an end portion 80 of the valve sleeve 38 may be provided with a stacked disk assembly 82 in place of the apertures 52 or 54. The stacked disk assembly 82 may include a first disk 84 and a second disk 86, or, as is shown in FIG. 4, a series of first disks 84 interspersed with a series of second disks 86. It will be noted that in the disclosed example, the first disk 84 and the second disk 86 are dissimilar. As an alternative, the stacked disk assembly 82 may be formed from a series of identical disks, with, for example, half of each disk formed to resemble the first disk 84 and half of each disk formed to resemble the second disk 86. In such an arrangement, each disk is oriented at a 180 degree offset relative to its next adjacent disk.

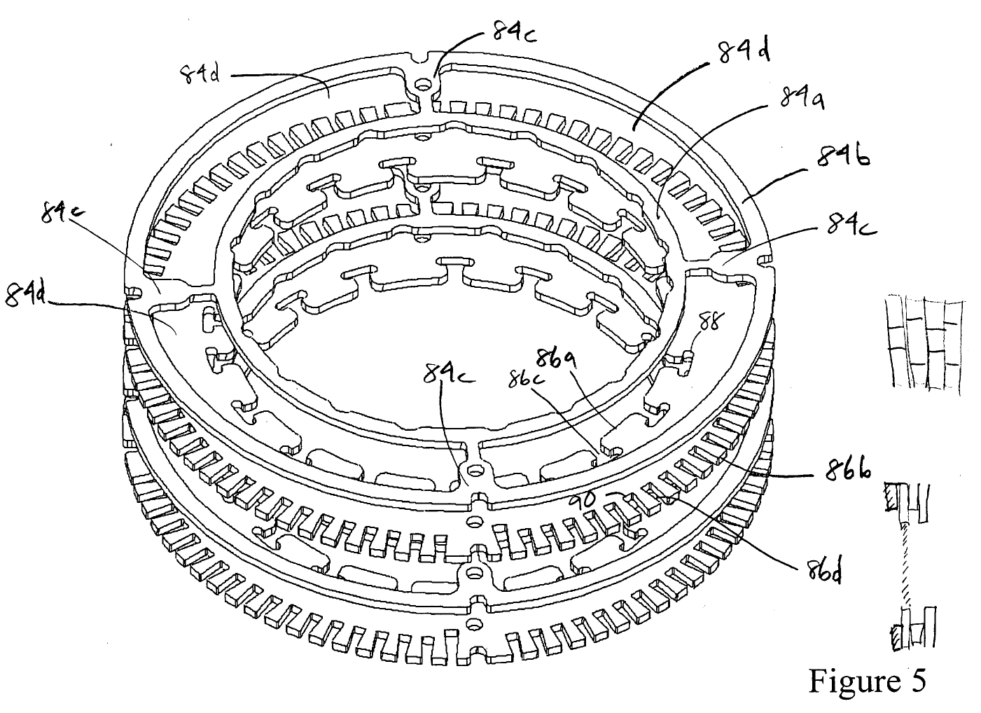

Referring to FIG. 5, the first disk or disks 84 include an inner ring 84a, an outer ring 84b, and a plurality of interconnecting arms 84c such that a plurality of open areas 84d are defined between the inner and outer rings 84a and 84b.

The second disk or disks 86 include an inner edge 86a and an outer edge 86b. The inner edge 86a includes a plurality of openings 86c while the outer edge 86b includes a plurality of openings 86d. At least a portion 88 of the openings 86d are shaped to overlie and communicate with the open area 84b of the first disk 84 when the stacked disk assembly 82 is fully assembled. Similarly, at least a portion 90 of the openings 86d overlie and communicate with the open area 84d of the first ring 84 when the stacked disk assembly 82 is fully assembled. Accordingly, a circuitous flow path is defined between an outer edge 82b of the stacked disk assembly and an inner edge 82a of the stacked disk assembly as the process medium proceeds through the openings 86d, the open area 84d, and the openings 86c.

In accordance with the exemplary forms disclosed herein regarding the valve sleeve 38, when the sleeve 38 is constructed to incorporate the apertures 52 as shown in FIG. 3 or the stacked disk assembly 82 shown in FIGS. 4 and 5, the sleeve 38 may have an additional attenuating effect on noise, vibration, and other service considerations. Also, it will be understood that the process medium flowing through the valve may be flowing in the opposite direction to that shown by the reference arrow A. In such a circumstance, the orientation of the apertures 54 may be, if desired, flip-flopped from that shown in FIG. 3, such that the process medium flowing in the opposite direction will encounter the narrowed first portion 74, the transition zone 78, and then the widened second portion 76. Again, other variable cross-sections (not shown) may be contemplated by those of skill in the art.

Referring now to FIG. 6, a valve actuation mechanism 100 is shown. The valve actuation mechanism may be used with the control valve 10 shown in FIGS. 2-4, or, as an alternative, the valve actuation mechanism 100 may be used in conjunction with a control valve 102 shown in FIG. 6 and which employs a generally cylindrical valve sleeve 104 and a conventionally shaped valve plug mount 106. The control valve 102 includes a body 108 having an inlet end 110 and an outlet end 112. A passage 114 is defined through the body 108 and includes an inlet passage 116, an outlet passage 118, and a control passage 120. The plug mount 106 is mounted within the body 108 of the control valve 102, with the plug mount 106 preferably being generally centrally located within the passage 114 of the body 108 such that the plug mount 106 is generally disposed along a longitudinal axis X of the body 108.

The valve actuation mechanism 100 includes a valve shaft 122 mounted in a shaft housing 124. The shaft includes a toothed end 126 which engages a corresponding track 128 formed on an external surface 130 of the valve sleeve 104. In the disclosed example, the external surface 130 of the valve sleeve 104 includes a recess 131, with the track 128 disposed generally within the recess 131. The valve shaft 122 includes a second end 132 which may include a handle 134 or which may be connected to a suitable actuator (not shown) suitable for rotating the valve shaft 122 about an axis Y. The shaft housing 124 may include a removable cap 136 which may be removed from the balance of the shaft housing 124 by unscrewing the cap 136 from a threaded receiving aperture 138. Suitable springs 140 and seals 142 may be provided as necessary in order to seal the shaft housing 124 and in order to prevent or limit potential leakage of the process medium through the shaft housing 124.

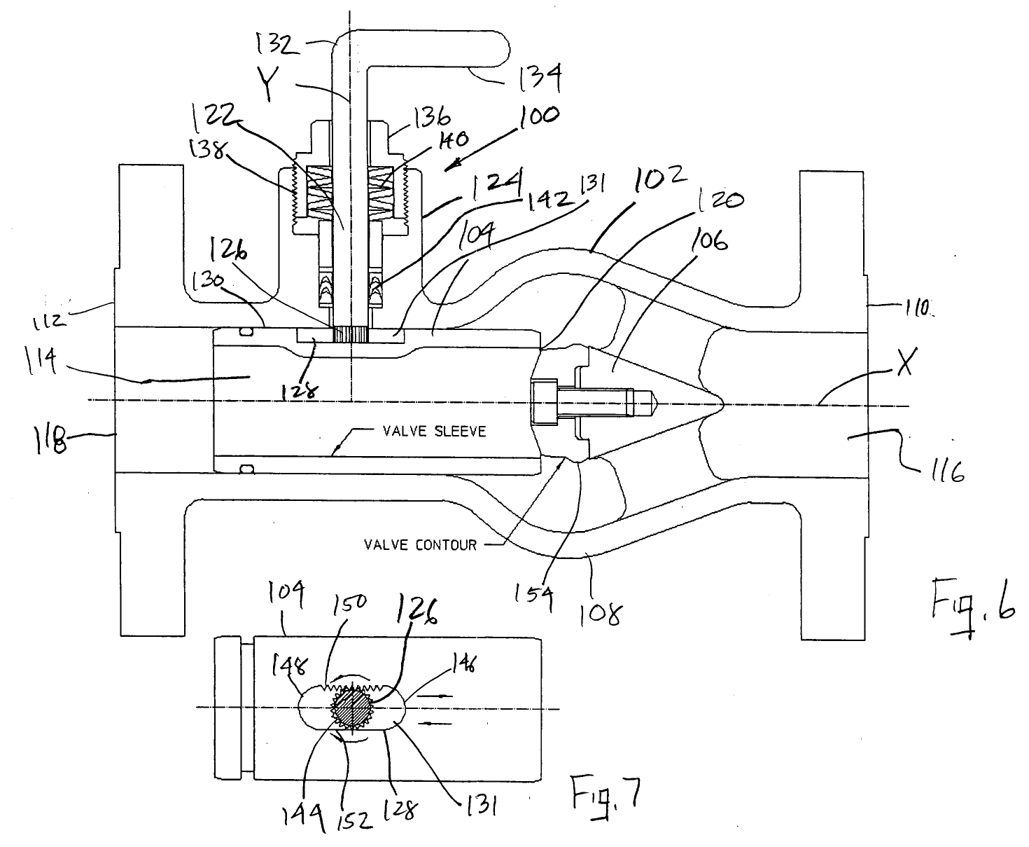

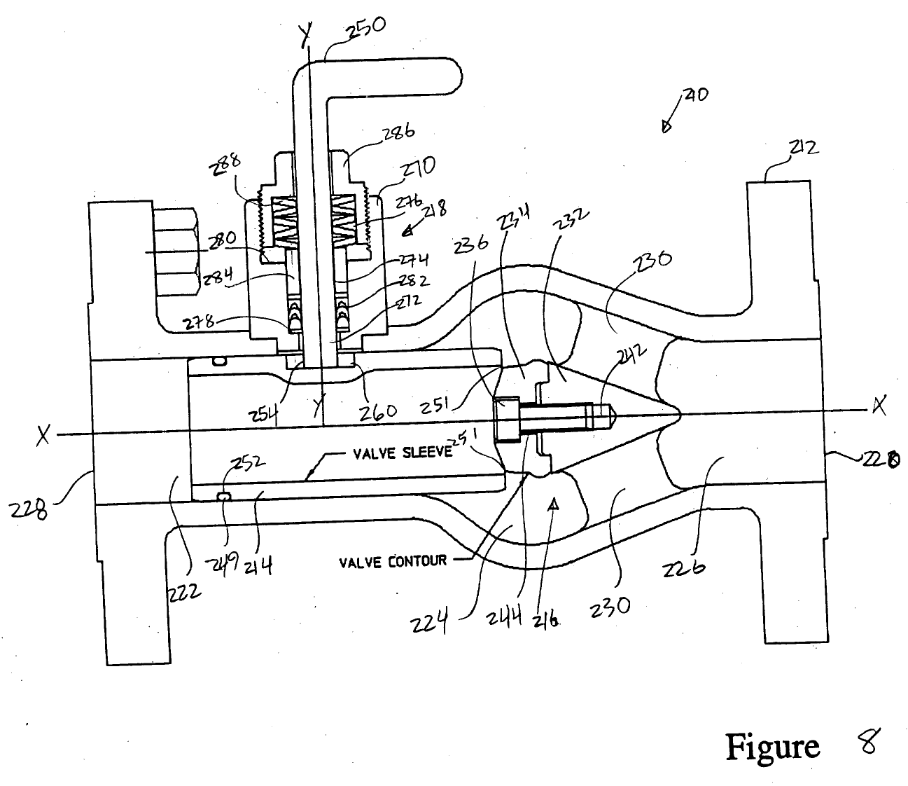

Referring now to FIG. 7, the toothed end 126 may take the form of a pinion 144. The track 128 includes a pair of ends 146, 148, and also includes a pair of elongated sides 150, 152, one of which is toothed to mesh with the pinion 144. It will be understood that upon rotating the valve shaft 122 about the axis Y will cause the valve sleeve 104 to shift between a position in which an end of the valve sleeve engages a valve contour 154 mounted to the plug mount 106 (in which position flow through the control valve is prevented), and a second position in which the valve sleeve 104 is shifted in a direction generally parallel to the axis X and away from the valve contour 154 (in which position flow through the control valve is enabled).

As will be apparent to those of skill in the art, certain features and aspects of the control valve 10 discussed above and shown in FIGS. 2, 2A, 3, 4 and 5 may be interchanged with certain features and aspects of the control valve 102 discussed above and shown in FIGS. 6 and 7. For example, the valve sleeve 64 of the control valve 102 may employ a system of apertures 52 as discussed above and as shown in FIG. 3, or the valve sleeve 64 may employ the stacked disk assembly 82 as discussed above and as shown in FIG. 4.

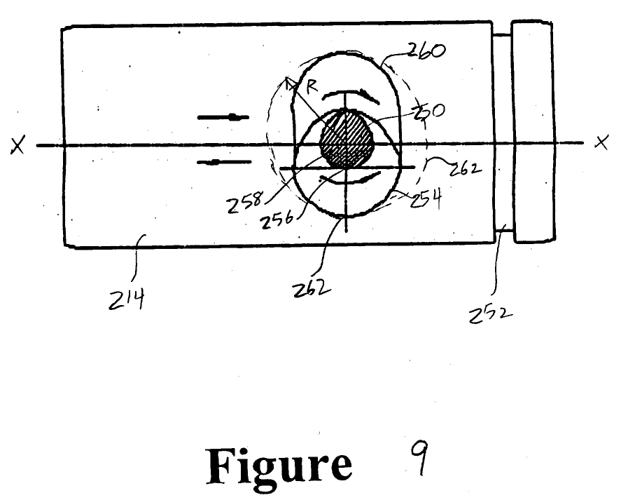

Referring now to FIGS. 8 and 9, a control valve assembled in accordance with the teachings of another preferred example of the present invention is generally referred to by the reference numeral 210. The control valve 210 includes a body 212, a sleeve 214, a valve plug mount 216, and a valve actuation mechanism 218. The sleeve 214 slidably moves within the body 212 under the influence of the valve actuation mechanism 218, thereby engaging and disengaging the valve plug mount 216 to open and close the control valve 210.

The body 212 includes an inlet 220, an inlet flow passage 222, a flow control passage 224, an outlet flow passage 226, and an outlet 228. The inlet 220, the inlet flow passage 222, the control valve passage 224, the outlet flow passage 226, and the outlet 228 may be designed in various shapes for flow pressure, velocity and direction control. For example, the inlet 220, the inlet flow passage 222, the control valve passage 224, the outlet flow passage 226, and the outlet 228 may be shaped and aligned with respect to each other so as to provide a substantially axial flow from the inlet 220 to the outlet 228. To minimize or control pressure drop across the sleeve valve 210, the flow diameter (i.e., the diameter of the process medium passing through a cross section of the body 212) may be maintained at a constant or a desired value, which may be approximately the same value as the diameter of the inlet 220. Accordingly, the diameters of the inlet flow passage 222, the flow control passage 224, the outlet flow passage 226, and the outlet 228 are sized to provide substantially the same flow diameter across the sleeve valve 210 as that of the inlet 220. For example, inside the body 212 where the valve plug mount 216 is disposed, the internal diameter of the flow control passage 224 is accordingly shaped to maintain a constant flow diameter with minimal pressure drop.

The valve plug mount 216 includes a number of vanes 230, a mounting base 232, a valve contour 234, and a mounting screw 236. The vanes 230 provide structural support for the mounting base 232 by fixedly attaching the mounting base 232 to the body 212. The vanes may be any size or shape and mounted in the body 212 in any manner. In the illustrated embodiment, the vanes 230 are parallel to the direction of the flow and have an airfoil shaped cross section to guide the flow towards the outlet 228 without substantially disturbing the flow inside and downstream of the control valve passage 224. The mounting base 232 may be cone shaped to converge the flow toward the outlet flow passage 226. The valve contour 234 may be fixedly or removably attached to the mounting base 232. As shown in FIG. 8, the valve contour 234 is removably attached to the mounting base 232 with a mounting screw 236. The mounting screw 236 screws into a correspondingly sized counter-bored threaded cavity 242 located inside of the mounting base 232, thus permitting the valve contour 234 to be securely and removably attached to the mounting base 232. The center of the valve contour 234 includes a bore 244 for accommodating the screw 236 when the valve contour 234 is secured to the mounting base 232. The bore 244 may be shaped so that the head of the screw 236 is positioned flush with the valve contour 234 when the valve contour 234 is securely attached to the mounting base 232. Flush positioning of the head of the screw 236 within the bore 244 prevents or reduces flow disturbances near the valve contour 234 caused by the head of the screw 236.

The sleeve 214 may be a cylindrical tube that is sized to slidably fit within the inlet flow passage 222. At a portion of the sleeve 214 near the inlet 220, a sealing member 249 is mounted in a circumferential recess 252. The sealing member 249 prevents the process medium from entering the clearance between the sleeve 214 and the inlet flow passage 222. The sealing member 249 may be a ring-type sealing member that is well known to those of ordinary skill in the art, such as an O-ring. The valve contour 234 may be constructed in any shape to plug the sleeve 214 for a sealable fit when the valve 210 is closed. For example, the valve contour 234 may be contoured to provide an adjustable gap 251 between the sleeve 214 and the valve contour 234. The slidable movement of the sleeve 214 to open and close the valve changes the size of the gap 251, thereby controlling flow rate of the process medium through the gap 251. Accordingly, the size and contour of the valve contour 234 may be designed to provide a desired flow rate through the gap 251 when the valve 210 is open.

Referring to FIG. 9, the valve actuation mechanism 218 includes a valve shaft 250 having a cam 254 disposed at one end thereof. The cam 254 is attached to the valve shaft 250 in an off-center/eccentric manner relative to an axis of rotation y-y of the valve shaft 250 (FIG. 8). Accordingly, the center 256 of the cross section of the cam 254 and the center 258 of the cross section of the valve shaft 250 are not aligned. The sleeve 214 includes a slot 260, in which the cam 254 rotates. Rotation of the valve shaft 250 causes rotation of the cam 254 within the slot 260, which in turn causes the movement of the sleeve 214 along the axis x-x of the body 212. In effect, the rotation of the valve shaft 250 causes the point 262 on the perimeter of the cam 254 to trace a circle 264 having radius R. Because the free movement of the cam 254 is restricted within the slot 260, and the circle 264 extends beyond the boundaries of the slot 260 along the x-x axis, rotation of the cam 254 causes the movement of the sleeve 214 along the x-x axis. As a result, the cam 254 and the slot 260 cooperatively convert the rotational motion of the valve shaft 250 about the y-y axis to the linear motion of the valve sleeve 214 along the x-x axis.

The valve shaft 250 is supported within a shaft housing 270, which is detachably attached to the body 212 (FIG. 8). The shaft housing 270 is bored through at three different diameters to provide a lower bore 272, a middle bore 274 and an upper bore 276. The diameter of the middle bore 274 is larger than the diameter of the lower bore 272, so that the transition from the lower bore 272 to the middle bore 274 defines a lower annular ledge 278. Similarly, the diameter of the upper bore 276 is larger than the diameter of the middle bore 274, so that the transition from the middle bore 274 to the upper bore 276 defines an upper annular ledge 280. A packing assembly 282 and a guide bushing 284 are concentrically located in the middle bore 274 between the valve shaft 250 and the shaft housing 270. The upper bore 276 is threaded for receiving a cylindrical packing nut 286 having counter-threading on its external surface. Within the packing nut 286, and concentrically located between the packing nut 286 and the valve shaft 250, one or more spring(s) 288 retain the guide bushing 284 and packing assembly 282 in place. In effect, the packing assembly 282 and the guide bushing 284 are confined in the middle bore 274 by the compressive force of the spring(s) 288 at one end, and by the lower annular ledge 278 at the other end. Tightening the packing nut 286 increases the compression force of the spring(s) 288, which in turn push(es) down on the guide bushing 284 and packing assembly 282 to enhance the seal between the packing assembly 282 and the valve shaft 250, if necessary.

The actuation mechanism 218 may be disassembled by removing the packing nut 286 from the shaft housing 270 to allow removal of the springs 288, the guide bushing 284 and the packing assembly 282, and subsequently detaching the shaft housing 270 from the body 212. Alternately, if only the detachment of the actuation mechanism 218 from the body 212 is desired, the shaft housing 270 may be detached from the body 212 without disassembly of the packing nut 286, springs 288, guide bushing 284, and the packing assembly 282.

The actuator mechanism 218 of the illustrated embodiment provides an easily releasable interface with the valve sleeve 214, which facilitates disassembly of the valve 210 for maintenance or other purposes. For example, the valve contour 234 may be removed and replaced with another valve contour 234 that has the same size, shape and contour, or with a valve contour 234 that has a different size, shape and contour. Before the valve contour 234 can be removed, however, an operator must remove the cam 254 from the slot 260 so that the sleeve 214 can be slidably removed from the body 212 through the inlet 220. Removal of the sleeve 214 from the body 212 allows access to the mounting screw 236. Removal of the mounting screw 236 allows detachment of the valve contour 234 from the mounting base 232. Once the valve contour 234 is detached from the mounting base 232, an operator can extract the valve contour 234 from the body 212 and install another valve contour 234. Replacement of the valve contour 234 may be necessary if, due to corrosion, wear and tear, or other maintenance related factors, the valve contour 234 and the sleeve 214 no longer provide adequate sealing for complete shut-off of the valve 210. Replacement of the valve contour 234 may also be desired to adapt the valve 210 to different process control conditions. For example, the valve contour 234 may be replaced if the valve 210 is to be used for control of gas flow instead of liquid flow. The valve contour 234 may also be replaced with another valve contour 234 having a different contour to provide a desired flow control across the valve 210. As those of ordinary skill in the art will readily appreciate, the ease in removal and replacement of the valve contour 234 provides adaptability of the valve 210 to different process control requirements. Also, removal and replacement of the valve contour 234 provides cost effective and rapid maintenance for the valve 210 if the seal between the valve sleeve 214 and the valve contour 234 should degrade with prolonged use.

As will be apparent to those of skill in the art, certain features and aspects of the control valves 10 and/or 102 discussed above and shown in FIGS. 2, 2A, and 3-7 may be interchanged with certain features and aspects of the control valve 210 discussed above and shown in FIGS. 8 and 9. For example, the valve sleeve 214 of the control valve 210 may employ the system of apertures 52 as discussed above and as shown in FIG. 3, or the valve sleeve 214 may employ the stacked disk assembly 82 as discussed above and as shown in FIG. 4.

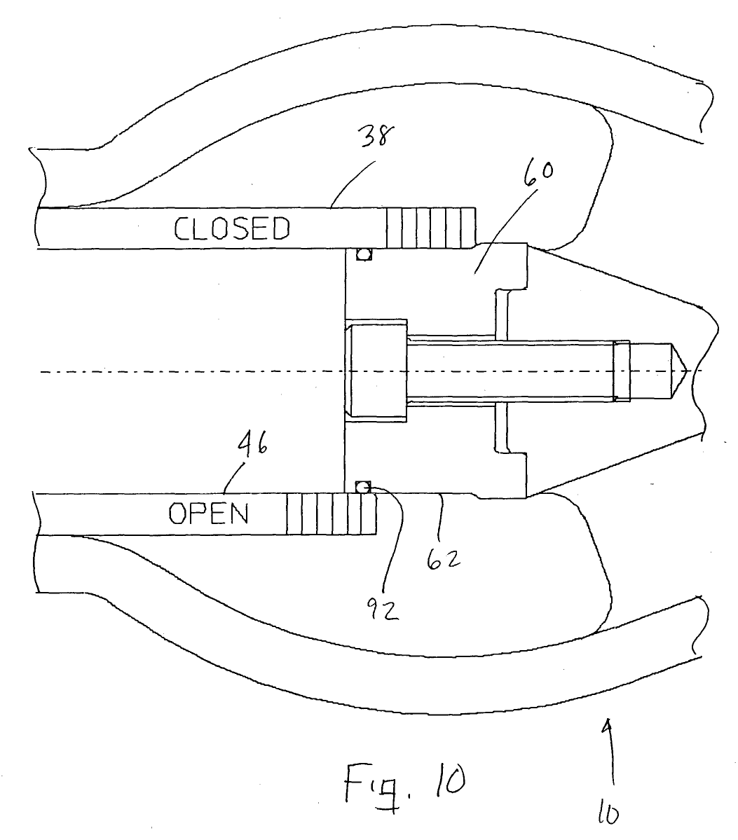

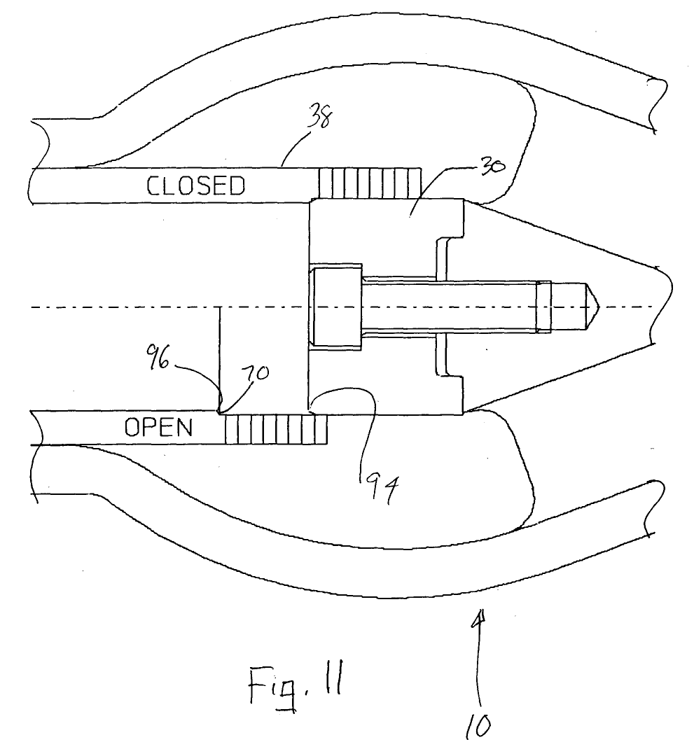

Referring now to FIG. 10, it will be noted that the valve contour 30 may be provided with a seal 92, which may serve to reduce or eliminate any leakage or flow between the inner surface 46 of the sleeve 38 and the outer surface 62 of the valve contour 30.

Referring now to FIG. 11, it will be noted that the valve seat 68 on the valve contour 30 may be disposed toward an end 94 of the valve contour, and the shaped portion 70 on the sleeve 38 may be located at 96 rather than at the end of the sleeve 38 as shown above in FIGS. 2, 2A, 3 and 4. This alternate construction again may serve to reduce or eliminate any leakage or flow between the inner surface 46 of the sleeve 38 and the outer surface 62 of the valve contour 30.

The above-described details in the various Figures need not be mutually exclusive. That is, in accordance with the spirit and scope of the preferred examples disclosed herein, one may pick and choose various aspects of the several Figures and combine those selected aspects with other selected aspects illustrated and described with respect to different Figures.

Numerous modifications and alternative embodiments of the invention will be apparent to those skilled in the art in view of the foregoing descriptions. Accordingly, these descriptions are to be construed as illustrative only and are for the purpose of teaching those skilled in the art the best mode or modes presently contemplated for carrying out the invention. The details of the structure or structures disclosed herein may be varied substantially without departing from the spirit of the invention, and the exclusive use of all modifications which come within the scope of the appended claims, either literally or under the doctrine of equivalents, is reserved.

What is claimed:

1. A severe service control valve comprising:
a valve body having an inlet, an outlet, and a flow passage extending between the inlet and the outlet;
a valve contour disposed within the valve body;
a tubular valve sleeve disposed within the valve body, the valve sleeve having a sidewall surrounding a bore, at least a portion of the bore disposed along the flow passage, the valve sleeve shiftably mounted within the valve body for movement between a first position and a second position, the valve sleeve cooperating with the valve contour to close the flow passage when the valve sleeve is in the first position; and
a plurality of apertures defined on the sidewall of the valve sleeve, the apertures arranged on the sidewall to be positioned in the flow passage when the valve sleeve is in the second position.

2. The control valve of claim 1, a portion of the valve contour defining a seat, the valve sleeve including an end adapted to form a seal against the seat when the valve sleeve is in the first position, the valve sleeve and the valve contour sized to define an annular flow path between an interior surface of the valve sleeve and an exterior surface of the valve contour, the annular flow path closed when the valve sleeve is in the first position, the annular flow path opened when the valve sleeve is moved away from the first position.

3. The control valve of claim 2, wherein the seat of the valve contour is defined at least in part by a circumferential shoulder formed on the valve contour.

4. The control valve of claim 1, wherein a first set of the apertures is disposed in the flow passage upon moving the valve sleeve a desired distance away from the first position.

5. The control valve of claim 4, wherein the plurality of apertures cooperate to define an area, and wherein a progressively greater portion of the area is disposed in the flow passage in response to moving the valve sleeve away from the first position.

6. The control valve of claim 5, wherein the plurality of apertures are arranged on the valve sleeve such that all of the plurality of apertures are positioned in the flow passage when the valve sleeve is in the second position.

7. The control valve of claim 1, wherein the apertures define at least a portion of a total flow area, the total flow area increasing in response to movement of the valve sleeve away from the first position.

8. The control valve of claim 1, including a peripheral clearance space defined between an inner surface of the valve sleeve and an outer surface of the valve contour, the peripheral clearance space forming at least a portion of a total flow area upon movement of the valve sleeve away from the first position.

9. The control valve of claim 1, wherein the flow passage includes a total flow area, a first portion of the total flow area defined by the plurality of apertures, a second portion of the total flow area defined by a peripheral clearance space formed between the valve sleeve and an outer surface of an extended portion of the valve contour, the total flow area increasing in response to movement of the valve sleeve away from the first position.

10. The control valve of claim 1, wherein the plurality of apertures are arranged on the valve sleeve such that at least a portion of the apertures are disposed in the flow path as the valve sleeve is shifted toward the second position, and wherein a total cross sectional area of the exposed apertures increases as the valve sleeve is shifted toward the second position.

11. The control valve of claim 1, wherein the valve contour includes an elongated portion extending away from a shoulder, the shoulder defining a valve seat, the elongated portion sized to limit movement of the valve sleeve in a direction transverse to a longitudinal axis of the valve sleeve.

12. The control valve of claim 1, wherein the valve sleeve includes an end sized to engage the valve contour when the valve contour is in the first position, and wherein the end comprises a plurality of stacked discs, the stacked discs cooperating to define the apertures by providing a flow path through the end of the valve sleeve.

13. A severe service control valve comprising:
a valve body having an inlet, an outlet, and a flow passage extending between the inlet and the outlet;
an elongated valve contour disposed within the valve body;
a tubular valve sleeve disposed within the valve body and having an end sized to be received over the valve contour, the valve sleeve having a sidewall surrounding a bore, the valve sleeve having an outer surface and an inner surface, at least a portion of the bore disposed along the flow passage, the valve sleeve shiftably mounted within the valve body for movement between a first position and a second position, the valve sleeve cooperating with the valve contour to close the flow passage when the valve sleeve is in the first position; and
a plurality of flow apertures defined through the sidewall of the valve sleeve and defining a flow path between the outer surface of the valve sleeve and the inner surface of the valve sleeve, the apertures arranged on the sidewall to be positioned in the flow passage when the valve sleeve is moved toward the second position.

14. The control valve of claim 13, wherein the end of the valve sleeve comprises a plurality of stacked discs, the stacked discs cooperating to define the apertures.

15. The control valve of claim 14, wherein each of the discs includes a plurality of shaped cutouts, the flow path extending through a first shaped cutout in a first one of the discs and through a second shaped cutout in an adjacent second one of the discs.

16. The control valve of claim 15, wherein the wherein a progressively greater number of the discs are disengaged from the elongated valve contour in response to movement of the valve sleeve away from the first position.

17. The control valve of claim 14, wherein the stacked discs cooperate to define at least a portion of a total flow area, the total flow area increasing in response to movement of the valve sleeve away from the first position.

18. The control valve of claim 17, including a peripheral clearance space defined between an inner surface of the stacked discs and an outer surface of the valve contour, the peripheral clearance space forming at least a portion of the total flow area upon movement of the valve sleeve away from the first position.

19. The control valve of claim 13, wherein the flow passage includes a total flow area, a first portion of the total flow area defined by the plurality of apertures, a second portion of the total flow area defined by a peripheral clearance space formed between the valve sleeve and an outer surface of an extended portion of the valve contour, the total flow area increasing in response to movement of the valve sleeve away from the first position.

20. The control valve of claim 13, wherein the plurality of apertures are defined by a plurality of bores through the sidewall of the valve sleeve.

21. The control valve of claim 20, wherein at least some of the bores have a variable cross section.

22. The control valve of claim 20, wherein at least some of the bores include an inlet having a first diameter and an outlet having a second diameter.

23. The control valve of claim 22, wherein the second diameter is greater than the first diameter, and including a transition section between the first diameter and the second diameter.

24. The control valve of claim 23, wherein the apertures are arranged on the valve sleeve to be exposed to the flow passage as the valve sleeve is shifted toward the second position such that a cross sectional area of the exposed apertures increases as the valve sleeve is shifted toward the second position.

25. A severe service control valve comprising:
a valve body having an inlet, an outlet, and a flow passage extending between the inlet and the outlet;
an elongated valve contour disposed within the valve body;
a tubular valve sleeve disposed within the valve body and having an end sized to be received over the valve contour, the valve sleeve having a sidewall surrounding a bore, the valve sleeve having an outer surface and an inner surface, at least a portion of the bore disposed along the flow passage, the valve sleeve shiftably mounted within the valve body for movement between a first position and a second position, the valve sleeve cooperating with the valve contour to close the flow passage when the valve sleeve is in the first position;
a plurality of flow apertures defined through the sidewall of the valve sleeve and defining a flow path between the outer surface of the valve sleeve and the inner surface of the valve sleeve, the apertures arranged on the sidewall to be positioned in the flow passage when the valve sleeve is moved toward the second position, a desired number of the apertures is disposed in the flow passage upon moving the valve sleeve a desired distance away from the first position; and
a portion of the valve contour defining a seat, the valve sleeve including an end adapted to form a seal against the seat when the valve sleeve is in the first position, the valve sleeve and the valve contour sized to define an annular flow path between an interior surface of the valve sleeve and an exterior surface of the valve contour, the annular flow path closed when the valve sleeve is in the first position, the annular flow path opened when the valve sleeve is moved away from the first position.

26. A severe service control valve comprising:
a valve body having an inlet, an outlet, and a flow passage extending between the inlet and the outlet;
a valve contour disposed within the valve body;
an attenuating tubular valve sleeve disposed within the valve body and having an end sized to be received over the valve contour, the valve sleeve having a sidewall surrounding a bore defining at least a portion of the flow passage;
an actuator engaging the valve sleeve and operable to shift the valve sleeve within the valve body between a first position and a second position, the valve sleeve cooperating with the valve contour to close the flow passage when the valve sleeve is in the first position, the actuator including a rotatable shaft, an outer portion of the sidewall arranged to engage an end of the shaft, the valve sleeve shiftable between the first and second positions in response to rotation of the shaft.

27. The control valve of claim 26, wherein the end of the shaft includes a pinion and the outer portion of the sidewall includes a rack disposed in a recess.

28. The control valve of claim 26, wherein the end of the shaft includes an eccentric cam, and wherein the outer portion of the sidewall incudes a slot operatively engaging the eccentric cam.
